(19) United States
(12) Patent Application Publication
(10) Pub. No.: US 2024/0150655 A1
(43) Pub. Date: May 9, 2024

(54) METHOD FOR MANUFACTURING FIBER MAT, AND FIBER MAT

(71) Applicant: Murata Manufacturing Co., Ltd., Nagaokakyo-shi (JP)

(72) Inventors: Hikaru MORIMOTO, Nagaokakyo-shi (JP); Kousuke YAMAZAKI, Nagaokakyo-shi (JP)

(21) Appl. No.: 18/414,784

(22) Filed: Jan. 17, 2024

Related U.S. Application Data
(63) Continuation of application No. PCT/JP22/14614, filed on Mar. 25, 2022.

(30) Foreign Application Priority Data
Jul. 26, 2021 (JP) 2021-121191

(51) Int. Cl. C09K 19/02; C08J 3/12; C08J 3/28; C09K 19/38

(52) U.S. Cl. CPC C09K 19/02; C08J 3/12; C08J 3/28; C09K 19/38; C08J 2300/12; C09K 2219/01

(57) ABSTRACT

A method for manufacturing a fiber mat includes: dispersing a fine fiber having thermoplasticity in a dispersion medium; extracting the fine fiber from the dispersion medium onto the support to form a mat; and applying light to a first main surface of the mat so as to fusion-bond the fine fiber located on the first main surface side of the mat, the first main surface being opposite to the support.

### CROSS REFERENCE TO RELATED APPLICATIONS

The present application is a continuation of International application No. PCT/JP2022/014614, filed Mar. 25, 2022, which claims priority to Japanese Patent Application No. 2021-121191, filed Jul. 26, 2021, the entire contents of each of which are incorporated herein by reference.

### TECHNICAL FIELD

The present invention relates to a method for manufacturing a fiber mat, and a fiber mat.

### BACKGROUND ART

As a conventional method for manufacturing a fiber sheet (fiber mat), Japanese Patent Laid-Open No. 2013-076196 (PTL 1) discloses a method for making a fiber sheet using a papermaking method. Specifically, PTL 1 discloses a method for forming a fiber sheet on a papermaking wire by supplying a fiber suspension having a fiber dispersed therein onto the papermaking wire and depositing the fiber on the papermaking wire.
PTL 1: Japanese Patent Laid-Open No. 2013-076196

### SUMMARY OF THE INVENTION

In recent years, a fiber sheet such as a non-woven cloth has been used not only as a filtration filter, an adsorbent, a heat insulator or the like but also as a printed wiring board material having an epoxy resin contained therein, and has been used in a wide variety of applications.

As a fiber constituting a fiber sheet becomes finer, the fiber sheet can be made thinner and variations in thickness can also be suppressed. In addition, an improvement in filter performance has been required in a fiber sheet, and it has been expected to manufacture a fiber sheet using a fine fiber in order to increase a specific surface area or to make a pore size small and collect a fine object.

A coater method and a papermaking method are mainly used as the technique of making a fiber into a sheet (mat). However, as a fiber becomes thinner and a specific surface area becomes larger, an amount of a solvent required to make the fiber wet becomes larger. Therefore, a solvent-collection-type method such as the papermaking method is advantageous in terms of cost.

When a fiber having a hydrogen bond, such as pulp, is extracted using the papermaking method, dehydration and drying after papermaking allow fibers in a formed fiber mat to have strength due to the hydrogen bond.

However, in the case of a chemical fiber that does not have a hydrogen bond, there is only a bond formed by entanglement of fibers. Therefore, particularly when the fiber has a short fiber length like a fine fiber, it is difficult to obtain strength sufficient for handling. Thus, it is conceivable to mix a substance serving as a binder to cause a fiber mat to have strength. In this case, however, the electrical property of the fiber mat becomes worse or the heat resistance of the fiber mat becomes worse, which leads to degradation in performance of the fiber mat.

As another method, the technique of heating and pressurizing fibers by a calender to compression-bond the fibers to have strength has been widely used. However, in thermal compression bonding using a calender, separation of a fiber mat from a mesh, a papermaking wire or the like is required. When a fine and particularly ultra-short fiber is used, a fiber mat does not have strength that can withstand the separation.

If calender processing is performed without separation, the fiber mat and the mesh or the papermaking wire are united and become inseparable. In addition, it is necessary to use a higher-melting-point material in the mesh or the papermaking wire than in the extracted fiber. Therefore, when a fine fiber of a high-melting-point resin, such as a liquid crystal polymer (LCP), is used, there is no inexpensive material that can deal with this.

The present invention has been made in light of the above-described problem, and an object of the present invention is to provide a method for manufacturing a fiber mat including a fine fiber and having high strength, and such a fiber mat.

A method for manufacturing a fiber mat based on the present disclosure includes: dispersing a fine fiber having thermoplasticity in a dispersion medium; extracting the fine fiber from the dispersion medium onto a support to form a mat; and applying light to a first main surface of the mat so as to fusion-bond the fine fiber located on the first main surface side of the mat, the first main surface being opposite to the support.

In the method for manufacturing the fiber mat based on the present disclosure, the fine fiber may have a melting point higher than a melting point of the support.

In the method for manufacturing the fiber mat based on the present disclosure, pulsed light is preferably applied.

In the method for manufacturing the fiber mat based on the present disclosure, the method may further include separating, from the support, the mat subjected to the application of light to the first main surface; and applying the light to a second main surface of the mat opposite to the first main surface so as to fusion-bond the fine fiber on the second main surface side of the mat.

In the method for manufacturing the fiber mat based on the present disclosure, the fine fiber may be a liquid crystal polymer powder.

In the method for manufacturing the fiber mat based on the present disclosure, the liquid crystal polymer powder preferably includes a fiber portion with particles having an aspect ratio of 10 times to 500 times and having an average diameter of 2 μm or less, the aspect ratio being a ratio of a length in a longitudinal direction to a fiber diameter.

A fiber mat based on the present disclosure incudes: a mat having a first surface layer portion and an intermediate layer portion located on a center side in a thickness directed relative to the first main surface; and a fine fiber having thermoplasticity fusion-bonded in the first surface layer portion.

In the fiber mat based on the present disclosure, the fiber mat preferably has a breaking strength of 45 cN/20 mm or more.

In the fiber mat based on the present disclosure, the fine fiber may be a liquid crystal polymer powder.

In the fiber mat based on the present disclosure, the liquid crystal polymer powder preferably includes a fiber portion with particles having an aspect ratio of 10 times to 500 times and having an average diameter of 2 μm or less, the aspect ratio being a ratio of a length in a longitudinal direction to a fiber diameter.

According to the present invention, there can be provided a method for manufacturing a fiber mat including a fine fiber and having high strength, and such a fiber mat.

### BRIEF DESCRIPTION OF THE DRAWINGS

FIG. 1 is a scanning electron micrograph showing an enlarged view of a first main surface of a fiber mat according to an embodiment.

FIG. 2 is a scanning electron micrograph showing a cross section of the fiber mat according to the embodiment in a thickness direction.

FIG. 3 is a flowchart showing a manufacturing process of the fiber mat according to the embodiment.

FIG. 4 shows the matting step of matting a liquid crystal polymer powder in the manufacturing process of the fiber mat.

FIG. 5 shows the step of applying light to a second surface of the fiber mat.

FIG. 6 shows evaluation conditions and evaluation results in Example 1, Example 2 and Comparative Example.

FIG. 7 shows evaluation conditions and evaluation results in Example 3 and Example 4.

FIG. 8 shows a breaking strength in Examples 1 to 4.

### DETAILED DESCRIPTION OF THE PREFERRED EMBODIMENTS

Hereinafter, an embodiment of the present invention will be described in detail with reference to the drawings. In the embodiment described below, the same or common portions will be denoted by the same reference characters in the drawings, and description thereof will not be repeated.

<Fiber Mat>

A fiber mat 30 according to the present embodiment is made of a fine fiber having thermoplasticity, and is specifically made of a liquid crystal polymer powder obtained by finely pulverizing and fiberizing a liquid crystal polymer. The liquid crystal polymer used in the liquid crystal polymer powder is, for example, a thermotropic liquid crystal polymer. A molecule of the liquid crystal polymer has a negative thermal expansion coefficient in an axial direction of a molecular axis and has a positive thermal expansion coefficient in a radial direction of the molecular axis. The liquid crystal polymer according to the present embodiment does not have an amide bond.

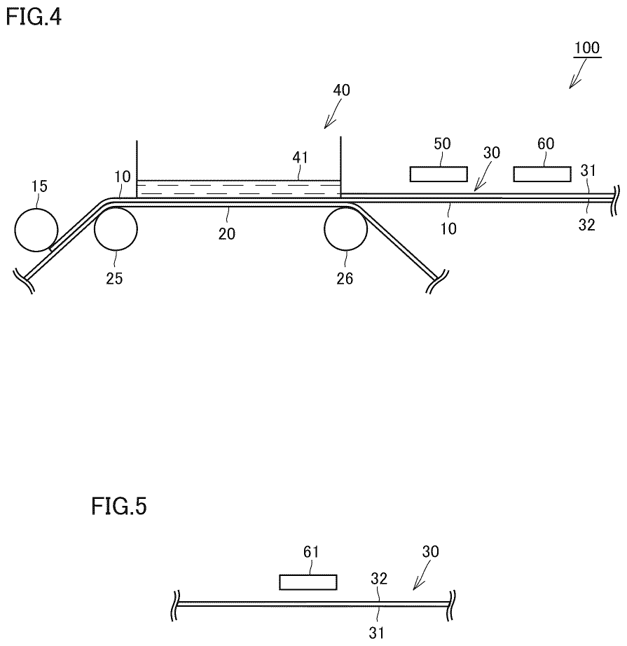

Fiber mat 30 according to the present embodiment has a plate-like shape and has a first main surface 31 (see FIG. 4) and a second main surface 32 (see FIG. 4) that face each other in a thickness direction.

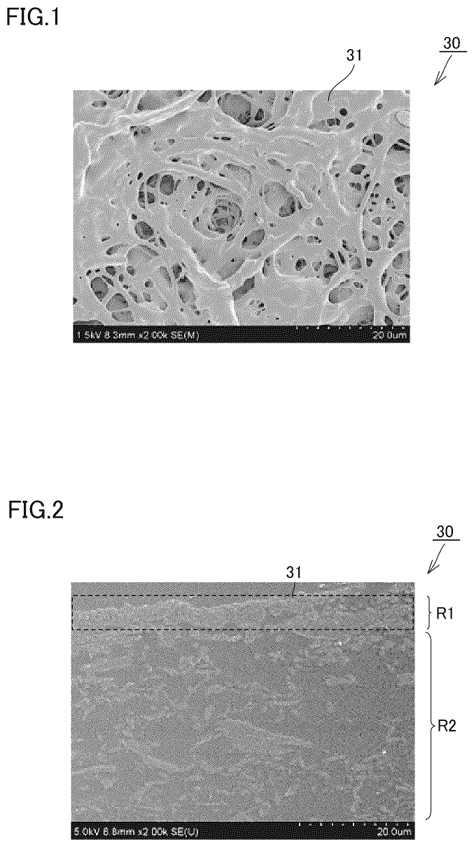

FIG. 1 is a scanning electron micrograph showing an enlarged view of the first main surface of the fiber mat according to the embodiment. FIG. 2 is a scanning electron micrograph showing a cross section of the fiber mat according to the embodiment in the thickness direction. In FIG. 2, a region surrounded by a dashed line is a first surface layer portion R1 of fiber mat 30 located on the first main surface side.

As shown in FIG. 1 and the region surrounded by the dashed line in FIG. 2, in fiber mat 30 according to the embodiment, the liquid crystal polymer powder is fusion-bonded on the first main surface 31 side. That is, the liquid crystal polymer powder is fusion-bonded in first surface layer portion R1 of fiber mat 30 located on the first main surface 31 side. In contrast, the liquid crystal polymer powder is not fusion-bonded in an intermediate layer portion R2 located on the center side in the thickness direction relative to the first main surface 31 side. As a result, fiber mat 30 has a density gradient from the first main surface 31 side to the central portion in the thickness direction. Specifically, a density on the first main surface 31 side is higher than a density on the central portion side in the thickness direction.

As described below, the liquid crystal polymer powder located on the second main surface 32 side may also be fusion-bonded. That is, the liquid crystal polymer powder may also be fusion-bonded in a second surface layer portion of fiber mat 30 located on the second main surface 32 side.

As described above, the liquid crystal polymer powder is fusion-bonded at least on the first main surface 31 side to have the density gradient in the thickness direction, which can bring about an increase in strength of fiber mat 30. When the liquid crystal polymer powder is fusion-bonded on both the first main surface 31 side and the second main surface 32 side, the strength of fiber mat 30 can be further increased.

A breaking strength of fiber mat 30 is preferably 45 cN/20 mm or more, and more preferably 50 cN/20 mm or more. Furthermore, the breaking strength of fiber mat 30 may be 115 cN/20 mm or more, or may be 350 cN/20 mm or more.

The breaking strength of fiber mat 30 can be measured using an autograph (AG-XDplus manufactured by Shimadzu Corporation). In this case, a width of fiber mat 30 during measurement is 20 mm.

An overall basis weight of fiber mat 30 is substantially 30 to 40 g/m². An overall density of fiber mat 30 is, for example, 0.30 to 0.60 g/cm³, and as the region of fusion-bonding of the liquid crystal polymer powder in the thickness direction becomes larger, the density increases.

A thickness of fiber mat 30 is substantially 50 to 100 μm, and as the region of fusion-bonding of the liquid crystal polymer powder in the thickness direction becomes larger, the thickness decreases.

<Film>

Fiber mat 30 described above is pressed and used as a film (more particularly, a liquid crystal polymer film). In the liquid crystal polymer film, metal foil such as copper foil may be joined to at least one surface thereof, or the above-described metal foil may be joined to both surfaces thereof. In this case, the liquid crystal polymer film according to the present embodiment can be used as one laminate-like molded body, e.g., as flexible copper clad laminates (FCCL) that allows circuit formation by a subtract method.

<Method for Manufacturing Fiber Mat>

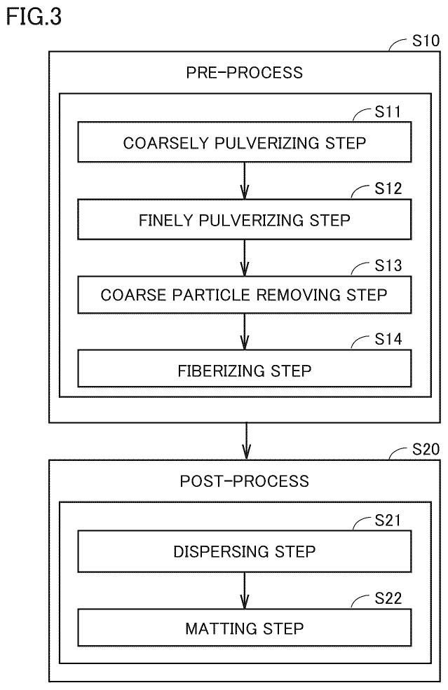

FIG. 3 is a flowchart showing a manufacturing process of the fiber mat. A method for manufacturing the fiber mat according to the present embodiment will be described with reference to FIG. 3.

As shown in FIG. 3, the method for manufacturing the fiber mat according to the present embodiment includes a coarsely pulverizing step (S11), a finely pulverizing step (S12), a coarse particle removing step (S13), and a fiberizing step (S14) in this order as a pre-process (S10), and further includes a dispersing step (S21) and a matting step (S22) as a post-process (S20) subsequent to the pre-process (S10).

<Pre-Process>

In the coarsely pulverizing step (S12), which is a first step of the pre-process (S10), a molded product of a liquid crystal polymer is first prepared as a raw material. Examples of the molded product of the liquid crystal polymer include a uniaxially-oriented pellet-like liquid crystal polymer, a biaxially-oriented film-like liquid crystal polymer, or a powdery liquid crystal polymer. From the perspective of the manufacturing cost, the pellet-like liquid crystal polymer or the powdery liquid crystal polymer that is more inexpensive than the film-like liquid crystal polymer is preferable, and the pellet-like liquid crystal polymer is more preferable as the molded product of the liquid crystal polymer. In the present embodiment, it is preferable that the molded product of the liquid crystal polymer should not include a liquid crystal polymer that is molded directly into a fiber using an electrospinning method, a melt blow method or the like. However, the molded product of the liquid crystal polymer may include a liquid crystal polymer processed into a fiber by crushing the pellet-like liquid crystal polymer or the powdery liquid crystal polymer.

Next, the molded product of the liquid crystal polymer is coarsely pulverized, to thereby obtain a coarsely-pulverized liquid crystal polymer. For example, the molded product of the liquid crystal polymer is coarsely pulverized using a cutter mill apparatus, to thereby obtain a coarsely-pulverized liquid crystal polymer. A particle size of the coarsely-pulverized liquid crystal polymer is not particularly limited, as long as the coarsely-pulverized liquid crystal polymer can be used as a raw material for the below-described finely pulverizing step. A maximum particle size of the coarsely-pulverized liquid crystal polymer is, for example, 3 mm or less.

A method for manufacturing the liquid crystal polymer film in the present embodiment does not necessarily need to include the coarsely pulverizing step (S11). For example, the molded product of the liquid crystal polymer may be directly used as the raw material for the finely pulverizing step, if the molded product of the liquid crystal polymer can be used as the raw material for the finely pulverizing step.

Next, in the finely pulverizing step (S12), the coarsely-pulverized liquid crystal polymer is pulverized in the state of being dispersed in liquid nitrogen, to thereby obtain a particulate finely-pulverized liquid crystal polymer as the liquid crystal polymer. In the finely pulverizing step (S12), the coarsely-pulverized liquid crystal polymer dispersed in liquid nitrogen is pulverized using media. The media are, for example, beads. From the perspective of handling liquid nitrogen, a bead mill that is relatively less problematic technically is preferably used in the finely pulverizing step (S12). Examples of the apparatus that can be used in the finely pulverizing step (S12) include “LNM-08”, which is a liquid nitrogen bead mill manufactured by Aimex Co., Ltd.

The pulverizing method for pulverizing the liquid crystal polymer in the state of being dispersed in liquid nitrogen in the finely pulverizing step (S12) in the present embodiment is different from a conventional freeze pulverization method. The conventional freeze pulverization method is a method for pulverizing a raw material to be pulverized, while pouring liquid nitrogen on the raw material to be pulverized and a pulverizing apparatus main body. However, most of liquid nitrogen has been vaporized at the time of pulverization of the raw material to be pulverized. That is, in the conventional freeze pulverization method, most of the raw material to be pulverized is not dispersed in liquid nitrogen at the time of pulverization of the raw material to be pulverized.

In the conventional freeze pulverization method, heat of the raw material to be pulverized, heat generated from the pulverizing apparatus, and heat generated by pulverization of the raw material to be pulverized vaporize liquid nitrogen in a very short time. Therefore, in the conventional freeze pulverization method, during pulverization, the raw material located in the pulverizing apparatus has a temperature that is much higher than −196° C., which is a boiling point of liquid nitrogen. That is, in the conventional freeze pulverization method, pulverization is performed under such a condition that the temperature in the pulverizing apparatus is normally approximately −100° C. or higher and 0° C. or lower. In the conventional freeze pulverization method, even when liquid nitrogen is supplied as much as possible, the temperature in the pulverizing apparatus is about −150° C. at the lowest.

Therefore, in the conventional freeze pulverization method, when a uniaxially-oriented pellet-like liquid crystal polymer or a coarsely-pulverized product of a pellet-like liquid crystal polymer is, for example, pulverized, pulverization progresses along a plane that is substantially parallel to an axial direction of a molecular axis of the liquid crystal polymer, and thus, a fiber-like liquid crystal polymer having a very large aspect ratio and having a fiber diameter much larger than 3 μm is obtained. That is, even when the uniaxially-oriented pellet-like liquid crystal polymer or the coarsely-pulverized product of the pellet-like liquid crystal polymer is pulverized in the conventional freeze pulverization method, a particulate finely-pulverized liquid crystal polymer as used in the present embodiment cannot be obtained.

In the present embodiment, the raw material to be pulverized is pulverized in the state of being dispersed in liquid nitrogen, and thus, the raw material can be pulverized in the state of being even further cooled as compared with the conventional freeze pulverization method. Specifically, the raw material to be pulverized having a temperature lower than −196° C., which is a boiling point of liquid nitrogen, can be pulverized. When the raw material to be pulverized having a temperature lower than −196° C. is pulverized, brittle fracture of the raw material to be pulverized is repeated, and thus, pulverization of the raw material progresses. Therefore, even when the uniaxially-oriented liquid crystal polymer is, for example, pulverized, not only fracture along a plane that is substantially parallel to an axial direction of a molecular axis of the liquid crystal polymer, but also brittle fracture along a plane that intersects with the above-described axial direction progresses. Thus, the particulate finely-pulverized liquid crystal polymer can be obtained.

In addition, in the finely pulverizing step (S12), using the media or the like, an impact continues to be applied, in the embrittled state, to the liquid crystal polymer that has become particulate in liquid nitrogen due to brittle fracture. As a result, a plurality of fine cracks are formed from an outer surface to the inside of the liquid crystal polymer obtained in the finely-pulverizing step (S12).

D50 of the particulate finely-pulverized liquid crystal polymer obtained in the finely pulverizing step (S12) is preferably 100 μm or less, and more preferably 50 μm or less. D50 is measured using a particle size distribution measuring apparatus in accordance with a laser diffraction scattering method. Thus, clogging of a nozzle with the particulate finely-pulverized liquid crystal polymer in the below-described fiberizing step can be suppressed.

Next, in the coarse particle removing step (S13), coarse particles are removed from the particulate finely-pulverized liquid crystal polymer obtained in the above-described finely pulverizing step (S12). For example, by sieving the particulate finely-pulverized liquid crystal polymer using a mesh, the particulate finely-pulverized liquid crystal polymer under the sieve is obtained and the particulate liquid crystal polymer over the sieve is removed. The coarse particles included in the particulate finely-pulverized liquid crystal polymer can thus be removed. Although the type of the mesh may be selected as appropriate, examples of the mesh include a mesh having a mesh opening of 100 μm. The mesh opening of the mesh can be changed as appropriate depending on a desired fiber length of a liquid crystal polymer powder. For example, a mesh having a mesh opening of approximately 5 μm to 50 μm may be used. In addition, the method for manufacturing the liquid crystal polymer powder according to the present embodiment does not necessarily need to include the coarse particle removing step (S13).

Next, in the fiberizing step (S14), the particulate liquid crystal polymer is crushed using a wet high-pressure crushing apparatus, to thereby obtain a liquid crystal polymer powder. In the fiberizing step (S14), the finely-pulverized liquid crystal polymer is first dispersed in a dispersion medium for the fiberizing step. Although the coarse particles do not necessarily need to be removed from the finely-pulverized liquid crystal polymer to be dispersed, the coarse particles are preferably removed. Examples of the dispersion medium for the fiberizing step include water, ethanol, methanol, isopropyl alcohol, toluene, benzene, xylene, phenol, acetone, methyl ethyl ketone, diethyl ether, dimethyl ether, hexane, a mixture thereof, or the like.

Next, the finely-pulverized liquid crystal polymer dispersed in the dispersion medium for the fiberizing step, i.e., the slurry-like finely-pulverized liquid crystal polymer is passed through the nozzle in the state of being pressurized at high pressure. By passing the finely-pulverized liquid crystal polymer through the nozzle at high pressure, the shear force or collision energy caused by high-speed flow in the nozzle acts on the liquid crystal polymer to crush the particulate finely-pulverized liquid crystal polymer, which causes fiberization of the liquid crystal polymer to progress. The liquid crystal polymer powder that can be used in the post-process can thus be obtained. From the perspective of applying high shear force or high collision energy, a nozzle diameter of the above-described nozzle is preferably as small as possible within a range where clogging of the above-described nozzle with the finely-pulverized liquid crystal polymer does not occur. Since the particulate finely-pulverized liquid crystal polymer in the present embodiment has a relatively small particle size, the nozzle diameter in the wet high-pressure crushing apparatus used in the fiberizing step can be made small. The nozzle diameter is, for example, 0.2 mm or less.

In the present embodiment, as described above, a plurality of fine cracks are formed in the particulate finely-pulverized liquid crystal polymer powder. Therefore, as a result of pressurization by the wet high-pressure crushing apparatus, the dispersion medium enters the finely-pulverized liquid crystal polymer through the fine cracks. Then, when the slurry-like finely-pulverized liquid crystal polymer passes through the nozzle and is located under normal pressure, the dispersion medium having entered the finely-pulverized liquid crystal polymer expands in a short time. The expansion of the dispersion medium having entered the finely-pulverized liquid crystal polymer causes fracture to progress from the inside of the finely-pulverized liquid crystal polymer. Therefore, fiberization progresses to the inside of the finely-pulverized liquid crystal polymer and the molecules of the liquid crystal polymer are separated into domain units aligned in one direction. As described above, in the fiberizing step in the present embodiment, the particulate finely-pulverized liquid crystal polymer obtained in the finely pulverizing step in the present embodiment is defibrated. Thus, it is possible to obtain the liquid crystal polymer powder that is lower in content rate of a lump portion and is made of a finer short fiber than a liquid crystal polymer powder obtained by crushing a particulate liquid crystal polymer obtained in the conventional freeze pulverization method.

In the fiberizing step (S14) in the present embodiment, the liquid crystal polymer powder may be obtained by crushing the finely-pulverized liquid crystal polymer a plurality of times using the wet high-pressure crushing apparatus. The number of times of crushing by the wet high-pressure crushing apparatus is preferably small. The number of times of crushing by the wet high-pressure crushing apparatus may be, for example, five times or less.

The obtained liquid crystal polymer powder is used as a raw material for the post-process. Now, the details of the liquid crystal polymer powder as a fine fiber will be described.

The liquid crystal polymer powder includes at least a fiber portion. The fiber portion is short-fiber-like particles having an aspect ratio of 10 times to 500 times or less and having an average diameter of 2 μm or less. The aspect ratio is a ratio of a length in a longitudinal direction to a fiber diameter. Such liquid crystal polymer powder including the fine short-fiber-like fiber portion having an aspect ratio of 10 times to 500 times and having an average diameter of 2 μm or less cannot be manufactured by a conventionally known manufacturing method.

For example, a liquid crystal polymer powder including the fiber portion having an aspect ratio of 10 times to 500 times cannot be manufactured only by an electrospinning method, which is a method for manufacturing a ultra-fine continuous long fiber. It is conceivable to spin a liquid crystal polymer ultra-fine long fiber of a continuous long fiber manufactured by the electrospinning method, and then, cut the liquid crystal polymer ultra-fine long fiber into a short fiber. However, there is a limit to cutting the above-described liquid crystal polymer ultra-fine long fiber of a continuous long fiber having a very small fiber diameter and having an approximately infinite aspect ratio into a short fiber. The liquid crystal polymer ultra-fine long fiber obtained by cutting the liquid crystal polymer ultra-fine long fiber of a continuous long fiber manufactured by the electrospinning method has an aspect ratio exceeding 500 times.

The value of the average diameter of the fiber portion is an average value of fiber diameters of a plurality of fibrous particles constituting the fiber portion. As described above, the liquid crystal polymer powder according to the present embodiment includes fine-fiber-like particles. The fiber diameters can be measured from image data of the fiber-like particles obtained when the fiber-like particles are observed using a scanning electron microscope.

The aspect ratio of the fiber portion is preferably 300 or less, and more preferably 100 or less. The average diameter of the fiber portion is preferably 1 μm or less.

The above-described fiber portion may be included in the liquid crystal polymer powder as an aggregation portion in which the fiber-like particles aggregate. In addition, in the above-described fiber portion, an axial direction of the molecules of the liquid crystal polymer constituting the fiber portion matches a longitudinal direction of the fiber portion. Since the liquid crystal polymer powder is manufactured through the above-described fiberizing step in the method for manufacturing the fiber mat according to the present embodiment, fracture occurs among a plurality of domains formed by the bunched molecules of the liquid crystal polymer, which causes the axial direction of the molecules of the liquid crystal polymer to be strongly oriented along the longitudinal direction of the fiber portion.

The liquid crystal polymer powder preferably includes, at a content rate of 20% or less, a lump portion that is not substantially fiberized. More preferably, the liquid crystal polymer powder does not include the lump portion. The content rate of the lump portion is evaluated by the number of the lump portion to the number of the aggregation portion included in the liquid crystal polymer powder. In the present embodiment, the aggregation portion having a maximum height greater than 10 μm when the liquid crystal polymer powder is placed on a plane corresponds to the lump portion, and the aggregation portion having a maximum height equal to or smaller than 10 μm corresponds to the fiber portion.

The lump portion may be included in the liquid crystal polymer powder as an aggregation portion in which particles aggregate while including lump particles. The lump portion is a liquid crystal polymer powder that is not substantially fiberized. The lump portion may have a flat outer shape.

In the present embodiment, a value of D50 of the liquid crystal polymer powder can be, for example, 13 μm or less. The value of D50 is measured by particle size measurement using a particle size distribution measuring apparatus in accordance with a laser diffraction scattering method.

The liquid crystal polymer powder used as a raw material for the post-process is not limited to the liquid crystal polymer powder manufactured in the above-described pre-process.

<Post-Process>

Next, the post-process (S20) will be described. In the dispersing step (S21), which is a first step of the post-process (S20), the above-described liquid crystal polymer powder is dispersed in a dispersion medium, to thereby obtain a slurry-like liquid crystal polymer powder. Since the above-described fine short-fiber-like liquid crystal polymer powder is used, the liquid crystal polymer powder can be dispersed in a highly viscous dispersion medium, and in turn, a uniform fiber mat can be manufactured.

Examples of the dispersion medium used in the dispersing step (S21) include water or ethanol, a mixture thereof, and the like. By using such a dispersion medium, the cost of the dispersion medium can be reduced and the fiber mat can be manufactured inexpensively.

The longitudinal direction of the fiber portion in the above-described liquid crystal polymer powder dispersed in the dispersion medium is considered not to be oriented in a particular direction in the dispersion medium.

Next, in the matting step (S22), the slurry-like liquid crystal polymer powder is molded into a liquid crystal polymer fiber mat using a papermaking method. In the papermaking method, the dispersion medium used in the dispersing step can be collected and reused, and thus, the fiber mat can be manufactured inexpensively.

FIG. 4 shows the matting step of matting the liquid crystal polymer powder in the manufacturing process of the fiber mat. The details of the matting step will be described with reference to FIG. 4.

As shown in FIG. 4, in the matting step, a papermaking machine 100 is used. Papermaking machine 100 includes a supply roller 15 that supplies a microporous sheet 10, a wind-up roller (not shown) that winds up microporous sheet 10, a papermaking wire 20, conveyance rollers 25 and 26, a storage portion 40 that stores a dispersion medium 41 having the above-described liquid crystal polymer powder dispersed therein, a heating apparatus 50, and a light irradiation apparatus 60.

Papermaking wire 20 is, for example, a papermaking net of approximately 80 to 100 meshes. That is, papermaking wire 20 has a pore size of approximately 150 μm to 180 μm. Papermaking wire 20 is conveyed by conveyance rollers 25 and 26 aligned in a conveyance direction. Conveyance roller 26 is arranged on the downstream side of conveyance roller 25. Papermaking wire 20 is conveyed by these conveyance rollers 25 and 26 to pass through storage portion 40.

Supply roller 15 supplies microporous sheet 10 onto papermaking wire 20. Microporous sheet 10 functions as a support that supports the liquid crystal polymer powder. Microporous sheet 10 arranged on papermaking wire 20 is conveyed by papermaking wire 20 to pass through storage portion 40. Microporous sheet 10 having passed through storage portion 40 is separated from papermaking wire 20 and wound up by the wind-up roller.

Microporous sheet 10 has a finer mesh than that of papermaking wire 20. Microporous sheet 10 preferably has substantially 157 meshes or more. That is, microporous sheet 10 preferably has a pore size of substantially 100 μm or less. Thus, the fine liquid crystal polymer powder dispersed in the dispersion medium can be collected.

More preferably, microporous sheet 10 has a pore size of approximately 5 μm to 50 μm. When the pore size of microporous sheet 10 is too small, the water filterability becomes worse and the time required for dehydration becomes longer. When the pore size of microporous sheet 10 is too large, the fine fiber (fine liquid crystal polymer powder) is not easily collected, which leads to poor yield.

When microporous sheet 10 having variations in pore size is selected, the texture of a formed fiber mat is affected. Therefore, when a high level of uniformity is required for a fiber mat, a mesh that is periodically woven in a net-like pattern is preferable. That is, a mesh having a uniform pore size and having evenly located pores is preferably used as microporous sheet 10.

A woven mesh having a pore size of 50 μm or less can, for example, be used as microporous sheet 10. A woven mesh made of a synthetic fiber such as polyester can, for example, be used as the woven mesh.

For example, a wet non-woven cloth having a basis weight of 15 g/m² or less may also be used as microporous sheet 10. A wet non-woven cloth made of a microfiber can be used as the wet non-woven cloth. The microfiber is made of, for example, a synthetic fiber such as polyester.

Heating apparatus 50 is arranged on the downstream side of storage portion 40 in the conveyance direction. Heating apparatus 50 heats and dries a liquid crystal polymer powder 30 extracted onto microporous sheet 10. A fiber mat is thus formed on microporous sheet 10.

Light irradiation apparatus 60 is arranged on the downstream side of heating apparatus 50 in the conveyance direction. Light irradiation apparatus 60 applies light to the fiber mat formed on microporous sheet 10. A flash lamp can, for example, be used as light irradiation apparatus 60.

Light irradiation apparatus 60 preferably applies pulsed light. Since the pulsed light is absorbed by a surface (first main surface 31) of the fiber mat, the support (microporous sheet 10) that supports the fiber mat is not degraded by the application of light. Therefore, even a material having a melting point lower than that of the fiber mat can be used as the support, which leads to a wider range of choices of the support. In addition, fusion-bonding of the fiber mat to the support can be prevented, and thus, the support can be repeatedly used. PulseForge (registered trademark) 1300 manufactured by NovaCentrix can be used as light irradiation apparatus 60.

The matting step (S21) includes the extracting step, the separating step, the drying step, and the light irradiation step. In the matting step (S21), the dispersed liquid crystal polymer powder is first extracted onto microporous sheet 10 in the extracting step. Specifically, microporous sheet 10 supplied onto papermaking wire 20 is conveyed by papermaking wire 20 to pass through storage portion 40. When doing so, the liquid crystal polymer powder dispersed in dispersion medium 41 stored in storage portion 40 is extracted onto microporous sheet 10.

Next, in the separating step, the microporous sheet onto which the dispersed liquid crystal polymer powder has been extracted is separated from papermaking wire 20. Specifically, microporous sheet 10 is wound up by the wind-up roller, such that microporous sheet 10 is conveyed in a direction different from papermaking wire 20. Papermaking wire 20 may be conveyed by conveyance roller 26 in a direction different from microporous sheet 10.

Next, in the drying step, the liquid crystal polymer powder extracted onto microporous sheet 10 is heated and dried by heating apparatus 50. Fiber mat 30 made of the liquid crystal polymer is thus formed on microporous sheet 10.

Next, in the light irradiation step, light is applied to first main surface 31 of fiber mat 30 located opposite to a side where microporous sheet 10 is located. The liquid crystal polymer powder located on the first main surface 31 side is thus fusion-bonded. As a result, the strength of fiber mat 30 is increased and fiber mat 30 can be conveyed to the next step without breakage.

Furthermore, since only the liquid crystal polymer powder located on a surface layer on the first main surface 31 side is fusion-bonded, the density of fiber mat 30 as a whole is low. Thus, high air permeability and high collection efficiency can be ensured.

In the wind-up step, fiber mat 30 subjected to the application of light is wound up by the above-described wind-up roller in the state of being arranged on microporous sheet 10.

FIG. 5 shows the step of applying light to the second surface of the fiber mat. As shown in FIG. 5, the matting step may further include the step of separating, from microporous sheet 10, fiber mat 30 subjected to the application of light to first main surface 31, and applying light to second main surface 32 of fiber mat 30 located opposite to a side where first main surface 31 is located. In this step, the fine fiber located on the second main surface 32 side is fusion-bonded by the application of light from a light irradiation apparatus 61. An apparatus similar to light irradiation apparatus 60 described above can be used as light irradiation apparatus 61. During the application of light, the light is applied while conveying fiber mat 30.

When the liquid crystal polymer powder is fusion-bonded on both the first main surface 31 side and the second main surface 32 side, the strength of fiber mat 30 can be further increased.

In addition, when fiber mat 30 is separated from microporous sheet 10, fiber mat 30 can be separated without breakage, because the liquid crystal polymer powder is fusion-bonded on the first main surface 31 side and fiber mat 30 has sufficient strength.

<Method for Manufacturing Film>

Next, fiber mat 30 is separated from microporous sheet 10 and fiber mat 30 is heat-pressed, to thereby obtain a liquid crystal polymer film. By the heat-pressing step, the thickness of the liquid crystal polymer film becomes thinner than that of fiber mat 30.

In the heat-pressing step, fiber mat 30 is heat-pressed together with, for example, copper foil. Thus, since the heat-pressing step also serves as the step of joining the liquid crystal polymer film and the copper foil to each other, the liquid crystal polymer film having the copper foil joined thereto can be obtained inexpensively. When fiber mat 30 is heated for a long time in the heat-pressing step, fiber mat 30 is preferably vacuum-heat-pressed.

In the heat-pressing step, heat-pressing is preferably performed at a temperature lower by about 5° C. to 15° C. than a melting point of the liquid crystal polymer constituting the liquid crystal polymer powder. When heat-pressing is performed at a temperature lower by about 5° C. to 15° C. than the above-described endothermic peak temperature, sintering of the liquid crystal polymers tends to progress.

In addition, in the heat-pressing step, a composite sheet including a heat-resistant resin and a reinforcing material such as a polyimide film, a PTFE film or a glass fiber fabric may be sandwiched as a release film between a press machine used in the heat-pressing step and fiber mat 30. Instead of the polyimide film, additional copper foil may be sandwiched between the press machine and fiber mat 30. The liquid crystal polymer film having the copper foil joined to both surfaces can thus be obtained. The liquid crystal polymer film having the copper foil joined to both surfaces can be used as a double-sided copper-clad FCCL.

The metal foil joined to the liquid crystal polymer film may be removed by etching or the like, as needed. The liquid crystal polymer film itself, to which no metal foil is joined, is thus obtained.

### EXPERIMENTAL EXAMPLES

Although the present invention will be described in more detail below with reference to examples, the present invention is not limited thereto. In experimental examples, fiber mat 30 according to each of Examples 1 to 4 was prepared, and the basis weight, the thickness, the density, and the breaking strength were measured for each of Examples 1 and 2, and the breaking strength was measured for each of Examples 3 and 4. The breaking strength was measured using an autograph (AG-XDplus manufactured by Shimadzu Corporation), by preparing fiber mat 30 having a width of 20 mm.

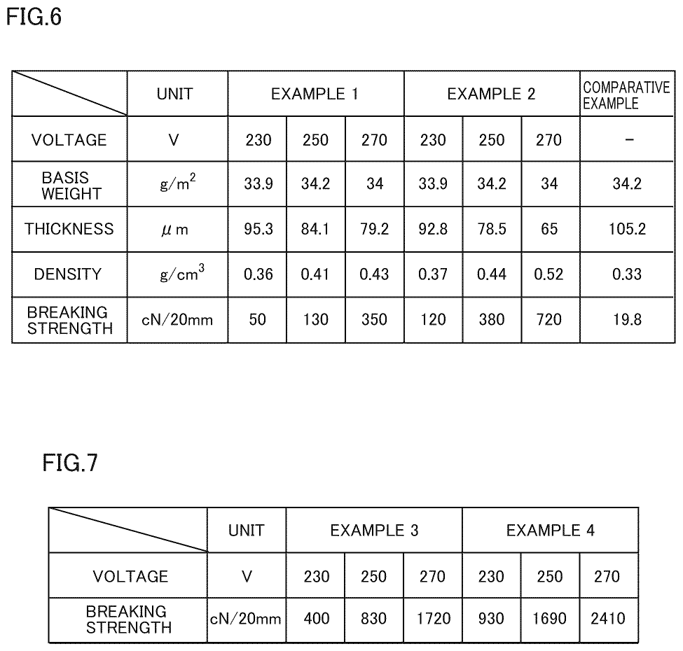

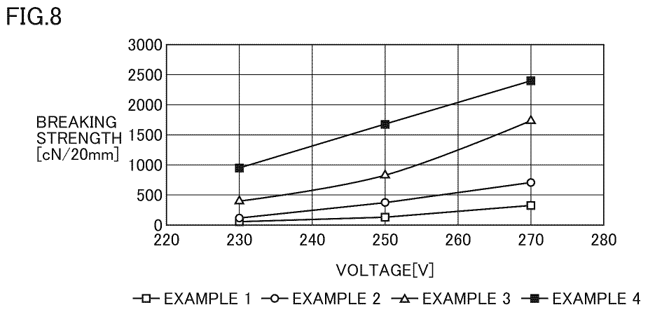

FIG. 6 shows evaluation conditions and evaluation results in Example 1, Example 2 and Comparative Example. FIG. 7 shows evaluation conditions and evaluation results in Example 3 and Example 4. FIG. 8 shows the breaking strength in Examples 1 to 4.

### Example 1

In Example 1, as a liquid crystal polymer molded product serving as a raw material, a pellet-like liquid crystal polymer was first introduced into a cutter mill apparatus and coarsely pulverized. In Example 1, a liquid crystal polymer having a melting point of 315° C. and having an absorption rate of 60% at the wavelength of 500 nm was used as the liquid crystal polymer. The coarsely-pulverized film-like liquid crystal polymer was discharged from a discharge hole of 3 mm in diameter provided in the cutter mill apparatus. A coarsely-pulverized liquid crystal polymer was thus obtained.

Next, the coarsely-pulverized liquid crystal polymer was finely pulverized using a liquid nitrogen bead mill (LNM-08 manufactured by Aimex Co., Ltd.). In pulverization using the liquid nitrogen bead mill, 30 g of the coarsely-pulverized liquid crystal polymer was introduced and pulverized for 120 minutes at the rotation speed of 2000 rpm, under such conditions that a vessel capacity was 0.8 L, beads having a diameter of 5 mm and made of zirconia were used as media, and an amount of introduction of the media was 500 mL. In the liquid nitrogen bead mill, the coarsely-pulverized liquid crystal polymer is dispersed in liquid nitrogen and subjected to wet pulverization. As described above, the coarsely-pulverized liquid crystal polymer was pulverized using the liquid nitrogen bead mill. A particulate finely-pulverized liquid crystal polymer was thus obtained.

Next, the finely-pulverized liquid crystal polymer was wet-classified using a mesh having a mesh opening of 100 μm, to remove coarse particles included in the finely-pulverized liquid crystal polymer and collect the finely-pulverized liquid crystal polymer having passed through the mesh. Although the mesh having a mesh opening of 100 μm was used in Example 1, a mesh having a mesh opening smaller than that of this mesh may be used for classification.

Next, the finely-pulverized liquid crystal polymer from which the coarse particles were removed was dispersed in a 20 wt % ethanol aqueous solution. The ethanol slurry having the finely-pulverized liquid crystal polymer dispersed therein was repeatedly crushed five times using a wet high-pressure crushing apparatus under such conditions that a nozzle diameter was 0.2 mm and a pressure was 200 MPa, and the ethanol slurry was thus fiberized. Starburst HJP-25060 manufactured by Sugino Machine Limited was used as the wet high-pressure crushing apparatus. A liquid crystal polymer powder dispersed in the ethanol aqueous solution was thus obtained.

Next, a required amount of water and ethanol were added and blended such that the liquid crystal polymer powder became 2.2 g with respect to 30 L of the 50 wt % ethanol aqueous solution, and the slurry-like liquid crystal polymer powder was molded into fiber mat 30 using a papermaking method. The square sheet machine 2555 manufactured by Kumagai Riki Kogyo Co., Ltd. was used as a papermaking machine, and the liquid crystal polymer powder dispersed in the dispersion medium was extracted onto a polyester mesh microporous sheet having a pore size of 11 μm.

Next, the liquid crystal polymer powder was heated and dried at the temperature of 100° C. using a hot air drier, and fiber mat 30 was molded on the microporous sheet. Fiber mat 30 had a basis weight of approximately 35 g/m².

Next, a plurality of fiber mats 30 were prepared, and light was applied to first main surface 31 of each fiber mat 30 while changing voltage conditions of a light irradiation apparatus (PulseForge (registered trademark) 1300 manufactured by NovaCentrix). The voltage was set at 230 V, 250 V and 270 V, and the pulse length was set at 3.5 ms.

Fiber mat 30 subjected to the application of light under the above-described conditions was separated from the microporous sheet, and the basis weight, the thickness, the density, and the breaking strength of fiber mat 30 according to Example 1 were measured by using a thickness measuring instrument (digital linear gauge DG-525H manufactured by Ono Seiki), by using a density measuring apparatus, or by performing a tensile test, or the like.

In Example 1, the basis weight, the thickness, the density, and the breaking strength of the mat subjected to the application of light at 230 V were 33.9 g/m², 95.3 μm, 0.36 g/cm³, and 50 cN/20 mm, respectively.

In Example 1, the basis weight, the thickness, the density, and the breaking strength of the mat subjected to the application of light at 250 V were 34.2 g/m², 84.1 μm, 0.41 g/cm³, and 130 cN/20 mm, respectively.

In Example 1, the basis weight, the thickness, the density, and the breaking strength of the mat subjected to the application of light at 270 V were 34 g/m², 79.2 μm, 0.43 g/cm³, and 350 cN/20 mm, respectively.

### Example 2

In Example 2, fiber mat 30 was made substantially similarly to Example 1, and light was also applied to second main surface 32 located opposite to first main surface 31 at the same energy as that in Example 1. That is, in Example 2, fiber mat 30 subjected to the application of light to first main surface 31 was separated from the microporous sheet, and then, light was further applied to second main surface 32. Similarly to Example 1, the voltage of the light irradiation apparatus PulseForge (registered trademark) 1300 manufactured by NovaCentrix when applying light to second main surface 32 was set at 230 V, 250 V and 270 V, and the pulse length was set at 3.5 ms. The basis weight, the thickness, the density, and the breaking strength of fiber mat 30 according to Example 2 were also measured similarly to Example 1.

In Example 2, the basis weight, the thickness, the density, and the breaking strength of the mat subjected to the application of light to both first main surface 31 and second main surface 32 at 230 V were 33.9 g/m², 92.8 μm, 0.37 g/cm³, and 120 cN/20 mm, respectively.

In Example 2, the basis weight, the thickness, the density, and the breaking strength of the mat subjected to the application of light to both first main surface 31 and second main surface 32 at 250 V were 34.2 g/m², 78.5 μm, 0.44 g/cm³, and 380 cN/20 mm, respectively.

In Example 2, the basis weight, the thickness, the density, and the breaking strength of the mat subjected to the application of light to both first main surface 31 and second main surface 32 at 270 V were 34 g/m², 65 μm, 0.52 g/cm³, and 720 cN/20 mm, respectively.

### Comparative Example

Comparative Example is different from Example 1 in that the light irradiation step in the matting step is omitted. That is, in a fiber mat according to Comparative Example, light is not applied to a surface (first main surface) and thus a fiber on the surface is not melted, as compared with fiber mat 30 according to Example 1.

In this case, the basis weight, the thickness, the density, and the breaking strength of the mat were 34.2 g/m², 105.2 μm, 0.33 g/cm³, and 19.8 cN/20 mm, respectively.

### Example 3

In Example 3, a liquid crystal polymer having a melting point of 315° C. and having an absorption rate of 70% at the wavelength of 500 nm was used as the liquid crystal polymer. Substantially similarly to Example 1 except for the above, fiber mat 30 was obtained.

In Example 3, the breaking strengths of the mat subjected to the application of light at 230 V, 250 V and 270 V were 400 cN/20 mm, 830 cN/20 mm and 1720 cN/20 mm, respectively.

### Example 4

In Example 4, a liquid crystal polymer having a melting point of 315° C. and having an absorption rate of 70% at the wavelength of 500 nm was used as the liquid crystal polymer. Substantially similarly to Example 2 except for the above, fiber mat 30 was obtained.

In Example 4, the breaking strengths of the mat subjected to the application of light at 230 V, 250 V and 270 V were 930 cN/20 mm, 1690 cN/20 mm and 2410 cN/20 mm, respectively.

As described above, it was confirmed that each fiber mat 30 had sufficient strength (breaking strength) in any of Examples 1 to 4, as compared with Comparative Example. It was also confirmed that increasing the voltage when applying light resulted in an increase in amount of the fusion-bonded liquid crystal polymer powder and a decrease in thickness, but resulted in an increase in density and breaking strength.

Furthermore, it was confirmed that the application of light to not only the first main surface 31 side but also the second main surface 32 side as in Example 2 and Example 4 resulted in further increase in breaking strength. In addition, when Examples 1 and 2 were compared with Examples 3 and 4, it was confirmed that the use of the liquid crystal polymer powder having a high absorption rate resulted in a further increase in breaking strength.

### Other Modifications

In the embodiment and examples above, the case in which the fine fiber is the liquid crystal polymer powder has been described by way of example. However, the fine fiber is not limited to the liquid crystal polymer powder. As described above, a chemical fiber that does not have a hydrogen bond may be used as the fine fiber, as long as the chemical fiber has thermoplasticity.

In the embodiment and examples above, the case in which the support onto which the finer fiber is extracted is the microporous sheet has been described by way of example. However, the present invention is not limited to this case. The microporous sheet may be omitted and papermaking wire 20 may be used as the support. In this case, a fine fiber having a fiber length greater than the pore size of papermaking wire 20 can be used as the fine fiber, and the fiber length may be 200 μm or less. Furthermore, a fine fiber having a fiber length of 1 mm or less may be used.

The embodiment and examples disclosed herein are illustrative and non-restrictive in every respect. The scope of the present invention is defined by the terms of the claims and is intended to include any modifications within the scope and meaning equivalent to the terms of the claims.

### REFERENCE SIGNS LIST

10 microporous sheet; 15 supply roller; 20 papermaking wire; 25, 26 conveyance roller; 30 fiber mat; 31 first main surface; 32 second main surface; 40 storage portion; 41 dispersion medium; 50 heating apparatus; 60 light irradiation apparatus; 100 papermaking machine.

1. A method for manufacturing a fiber mat, the method comprising:
dispersing a fine fiber having thermoplasticity in a dispersion medium;
extracting the fine fiber from the dispersion medium onto a support to form a mat; and
applying light to a first main surface of the mat so as to fusion-bond the fine fiber located on the first main surface side of the mat, the first main surface being opposite to the support.

2. The method for manufacturing the fiber mat according to claim 1, wherein the fine fiber has a melting point higher than a melting point of the support.

3. The method for manufacturing the fiber mat according to claim 1, wherein the light is pulsed light.

4. The method for manufacturing the fiber mat according to claim 1, further comprising:
separating, from the support, the mat subjected to the application of light to the first main surface; and
applying the light to a second main surface of the mat opposite to the first main surface so as to fusion-bond the fine fiber on the second main surface side of the mat.

5. The method for manufacturing the fiber mat according to claim 1, wherein the fine fiber is a liquid crystal polymer powder.

6. The method for manufacturing the fiber mat according to claim 5, wherein the liquid crystal polymer powder includes a fiber portion with particles having an aspect ratio of 10 times to 500 times and having an average diameter of 2 μm or less, the aspect ratio being a ratio of a length in a longitudinal direction to a fiber diameter.

7. The method for manufacturing the fiber mat according to claim 1, wherein an overall basis weight of the fiber mat is 30 to 40 g/m².

8. The method for manufacturing the fiber mat according to claim 1, wherein an overall density of the fiber mat is 0.30 to 0.60 g/cm³.

9. The method for manufacturing the fiber mat according to claim 1, wherein a thickness of the fiber mat is 50 to 100 μm.

10. A fiber mat comprising:
a mat having a first surface layer portion and an intermediate layer portion located on a center side in a thickness directed relative to the first main surface; and
a fine fiber having thermoplasticity fusion-bonded in the first surface layer portion.

11. The fiber mat according to claim 10, wherein
the mat has a density gradient from the first surface layer portion to the central portion of the mat in the thickness direction, and
a density of the first surface layer portion is higher than a density of the intermediate portion.

12. The fiber mat according to claim 10, wherein the fiber mat has a breaking strength of 45 cN/20 mm or more.

13. The fiber mat according to claim 10, wherein the fine fiber is a liquid crystal polymer powder.

14. The fiber mat according to claim 13, wherein the liquid crystal polymer powder includes a fiber portion with particles having an aspect ratio of 10 times to 500 times and having an average diameter of 2 μm or less, the aspect ratio being a ratio of a length in a longitudinal direction to a fiber diameter.

15. The fiber mat according to claim 10, wherein an overall basis weight of the fiber mat is 30 to 40 g/m².

16. The fiber mat according to claim 10, wherein an overall density of the fiber mat is 0.30 to 0.60 g/cm³.

17. The fiber mat according to claim 10, wherein a thickness of the fiber mat is 50 to 100 μm.
